(19) United States
(12) Patent Application Publication
(10) Pub. No.: US 2019/0114208 A1
(43) Pub. Date: Apr. 18, 2019

(54) INFORMATION PROCESSING APPARATUS

(71) Applicant: FUJI XEROX CO., LTD., Tokyo (JP)

(72) Inventor: Yoshiaki YABE, Kanagawa (JP)

(73) Assignee: FUJI XEROX CO., LTD., Tokyo (JP)

(21) Appl. No.: 16/152,426

(22) Filed: Oct. 5, 2018

(30) Foreign Application Priority Data
Oct. 18, 2017 (JP) 2017-201900

(51) Int. Cl. G06F 9/50

(52) U.S. Cl. CPC G06F 9/5011; G06F 3/0482

(57) ABSTRACT

An information processing apparatus includes a specifying unit and a presenting unit. The specifying unit specifies a software resource that can be provided to a user as a trial environment, based on information on a dependency relationship between resources including a software resource and a hardware resource and information on the software resource and the hardware resource in a use environment of the user. The presenting unit presents the software resource specified by the specifying unit.

### CROSS-REFERENCE TO RELATED APPLICATIONS

This application is based on and claims priority under 35 USC 119 from Japanese Patent Application No. 2017-201900 filed Oct. 18, 2017.

### BACKGROUND

### (i) Technical Field

The present invention relates to an information processing apparatus.

### (ii) Related Art

In a case of using or purchasing hardware resources or software resources, usability such as functions and operability may be checked by using a trial version (experience version, trial use version) in advance.

### SUMMARY

According to an aspect of the invention, there is provided an information processing apparatus including a specifying unit that specifies a software resource that can be provided to a user as a trial environment, based on information on a dependency relationship between resources including a software resource and a hardware resource and information on the software resource and the hardware resource in a use environment of the user; and a presenting unit that presents the software resource specified by the specifying unit.

### BRIEF DESCRIPTION OF THE DRAWINGS

Exemplary embodiment(s) of the present invention will be described in detail based on the following figures, wherein:

FIG. 1 is a diagram showing an overall configuration of a providing system according to a present exemplary embodiment;

FIG. 2 is a diagram showing a hardware configuration example of a computer that realizes a providing server, user management, a client terminal, and the like;

FIG. 3 is a diagram illustrating a functional configuration of the providing server;

FIGS. 4A to 4C are diagrams showing examples of information held in a user environment information holding unit, FIG. 4A is a diagram showing software resource information, FIG. 4B is a diagram showing affiliation information, and FIG. 4C is a diagram showing hardware resource information;

FIG. 5 is a diagram showing an example of information held in a dependency information holding unit;

FIGS. 6A and 6B are diagrams showing an example of information held in a trial environment use information holding unit, FIG. 6A is a diagram showing installation destination information, and FIG. 6B is a diagram showing job execution information;

FIG. 7 is a diagram illustrating a functional configuration of a user management server;

FIG. 8 is a diagram illustrating a functional configuration of a client terminal;

FIG. 9 is a flowchart showing operations of the providing server in a case of constructing a trial environment; and

FIG. 10 is a flowchart showing operations of the providing server in a case of officially introducing software resources.

### DETAILED DESCRIPTION

Hereinafter, an exemplary embodiment of the present invention will be described in detail with reference to the accompanying drawings.

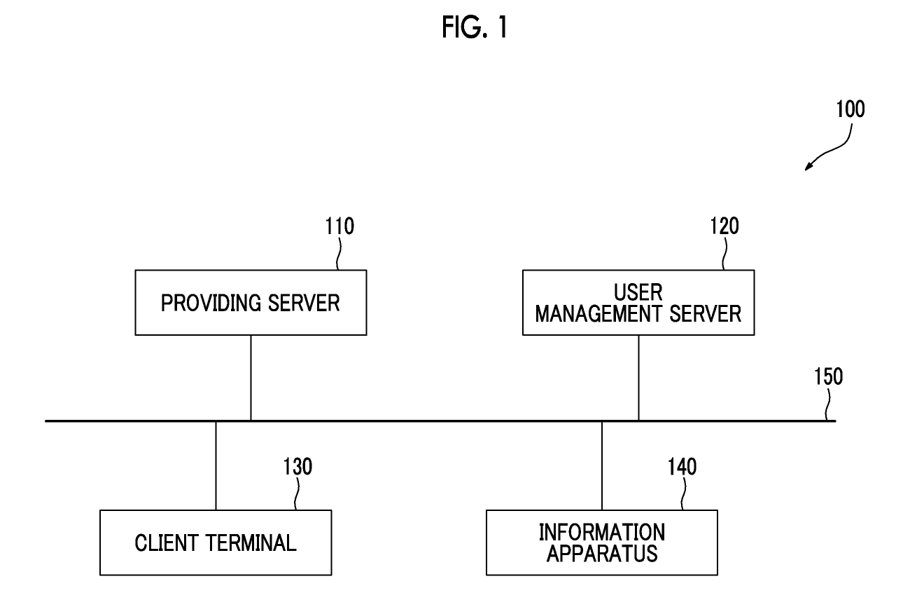

Overall configuration of providing system FIG. 1 is a diagram showing an overall configuration of a providing system according to the present exemplary embodiment. A providing system 100 according to the present exemplary embodiment includes a providing server 110, a user management server 120, a client terminal 130, and an information apparatus 140. The above devices are connected through a network 150 with each other. In addition, although not specifically shown, a server that provides various services online is connected to the network 150.

The providing server 110 is a server (site) that provides software resources to the user, and is an information processing apparatus. Here, the software resource is a software product or a service that is used by the user using his or her client terminal 130 or available information apparatus 140. The software resources by the providing server 110 may be sold for a price. The services as the software resources provided by the providing server 110 include services (Web services and cloud services) provided by various servers on the network 150 described above.

In addition, the providing server 110 provides a trial version software resource (a trial software resource) in advance, in a case where the user intends to receive new software resources. In the present exemplary embodiment, the providing server 110 does not provide an individual trial version for each software resource selected by the user, but rather constructs and provides a use environment of the user including the trial version software resource. The use environment of the user including the trial version software resource is a user environment in which the user actually uses the trial version software resource, reflecting the dependency relationship between software resources including the trial version software resource and hardware resources. Here, the hardware resources are hardware (devices) such as the client terminal 130 and the information apparatus 140. Hereinafter, the user environment is called a trial environment. In other words, the trial environment is a combination of software resources and hardware resources that can be introduced together into one use environment. The trial version software resource is a software resource to be newly introduced and is a software resource constituting the trial environment. By using the trial version software resource in this trial environment, the user can experience the same usability as in a case where the software resource is actually introduced (officially introduced).

The user management server 120 is a server (site) that manages user information and information on use of user's software resources and hardware resources in the user environment. The user management server 120 manages software resources and hardware resources introduced into the user environment by the user. In addition, the user management server 120 manages information on use of the trial version software resource provided to the user in the trial environment. The user management server 120 may manage the user and various resources used by the user according to a multi-tenant type management method. A tenant is a unit for managing the use of resources by the user. The multi-tenant type management method is a management method in which plural tenants are set and management is performed for each tenant.

The client terminal 130 is a terminal device for using software resources and hardware resources introduced into the user environment. The client terminal 130 is, for example, a personal computer, a portable information terminal such as a tablet terminal or a smartphone, or other information terminals that can access the providing server 110 through the network 150. The client terminal 130 acquires software or licenses from the providing server 110, executes the acquired software, or uses services provided by various servers using the acquired licenses. Further, the client terminal 130 may be connected to the information apparatus 140 through the network 150 and used as a terminal that uses the functions of the information apparatus 140 by a remote operation.

The information apparatus 140 is an information processing apparatus connectable to the network 150 used by the user, an apparatus other than the client terminal 130, and is managed by the user management server 120. That is, the information apparatus 140 is a hardware resource introduced into the user environment. The information apparatus 140 itself has a user interface, and similar to the client terminal 130, it can be an operation target apparatus that the user directly operates. The information apparatus 140 is realized by, for example, an office apparatus or the like having a communication function for connecting to the network 150. Specifically, there are a copying machine, a scanner, a facsimile transceiver, a printer, and a multifunction peripheral having these functions in combination. Further, an information terminal such as a personal computer or a tablet terminal shared in an office (not individually associated with a user) may be used as the information apparatus 140. In a case where the information apparatus 140 is remotely operated from the client terminal 130, the client terminal 130 and the information apparatus 140 may be connected to the client terminal 130 through a network different from the network 150.

The network 150 is a communication network used for data communication between apparatuses constituting the providing system 100. The type of the network 150 is not particularly limited as long as it can transmit and receive data. For example, the network 150 may be the Internet, a local area network (LAN), a wide area network (WAN), or the like. The communication line used for data communication may be wired or wireless. Further, a configuration in which devices are connected through plural networks or communication lines may be adopted. In the case where the client terminal 130 and the information apparatus 140 are connected through a network different from the network 150, it may be configured that a LAN (router of the LAN) to which the client terminal 130 and the information apparatus 140 are connected is connected to the network 150.

Hardware Configuration of Each Apparatus

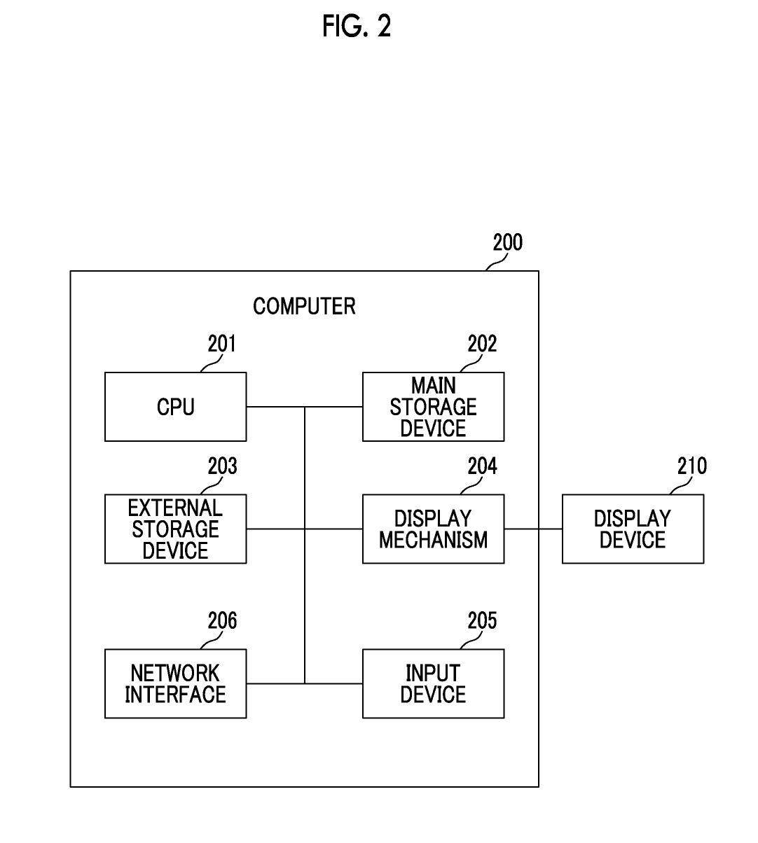

FIG. 2 is a diagram showing a hardware configuration example of a computer that realizes the providing server 110, the user management server 120, the client terminal 130, and the like. The computer 200 shown in FIG. 2 includes a central processing unit (CPU) 201 which is a computing unit, a main storage device (main memory) 202 as storage units, and an external storage device 203. The CPU 201 reads the program stored in the external storage device 203 into the main storage device 202 and executes it. As the main storage device 202, for example, a random access memory (RAM) is used. As the external storage device 203, for example, a magnetic disk device, a solid state drive (SSD) or the like is used. In addition, the computer 200 includes a display mechanism 204 for displaying and outputting data on a display device (display) 210, and an input device 205 for performing an input operation by an operator to the computer 200. As the input device 205, for example, a keyboard, a mouse, or the like is used. The computer 200 also includes a network interface 206 for connecting to the network 150.

The configuration of the computer 200 shown in FIG. 2 is only an example, and is not limited to the configuration example of FIG. 2. For example, a nonvolatile memory such as a flash memory or a read only memory (ROM) may be provided as a storage device. In addition, specific configurations may be different depending on the application targets of the providing server 110, the user management server 120, the client terminal 130, and the like. For example, in a case where the client terminal 130 is realized by a tablet terminal or the like, a touch panel in which a touch sensor and a liquid crystal display are combined is used as the input device 205. In addition, each of the providing server 110 and the user management server 120 may be configured as a single computer 200 as shown in FIG. 2, or may be configured to be realized by distributed processes by plural computers 200.

Functional Configuration of Providing Server

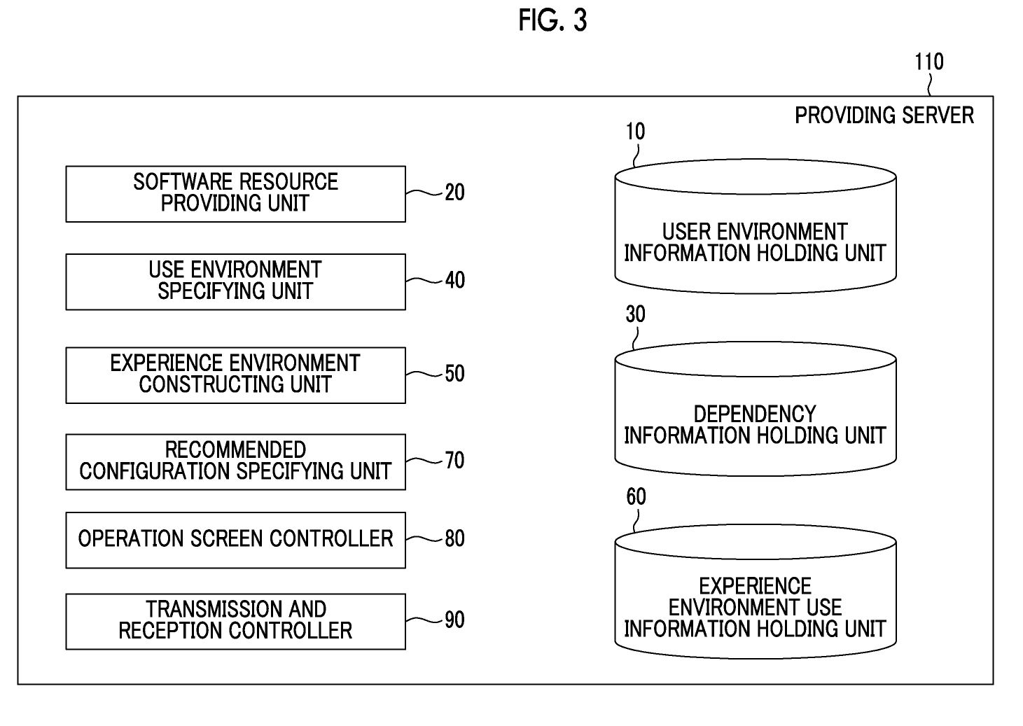

FIG. 3 is a diagram illustrating a functional configuration of the providing server 110. As illustrated in FIG. 3, the providing server 110 includes a user environment information holding unit 10, a software resource providing unit 20, a dependency information holding unit 30, a use environment specifying unit 40, a trial environment constructing unit 50, a trial environment use information holding unit 60, a recommended configuration specifying unit 70, an operation screen controller 80, and a transmission and reception controller 90. The user environment information holding unit 10, the dependency information holding unit 30 and the trial environment use information holding unit 60 are realized by storage units such as the main storage device 202 and the external storage device 203, for example, in the computer 200 shown in FIG. 2. The software resource providing unit 20, the use environment specifying unit 40, the trial environment constructing unit 50, the recommended configuration specifying unit 70, and the operation screen controller 80 are realized by the CPU 201 executing a program, for example, in the computer 200 shown in FIG. 2.

The user environment information holding unit 10 is a holding unit that holds information on software resources and hardware resources already introduced into the user environment. Specifically, the held information includes information for specifying software packages and services for which the user has a license, information on installation destinations, information for specifying the information apparatus 140 usable by the user, and the like. For example, these pieces of information are acquired from the user management server 120 and held in the user environment information holding unit 10.

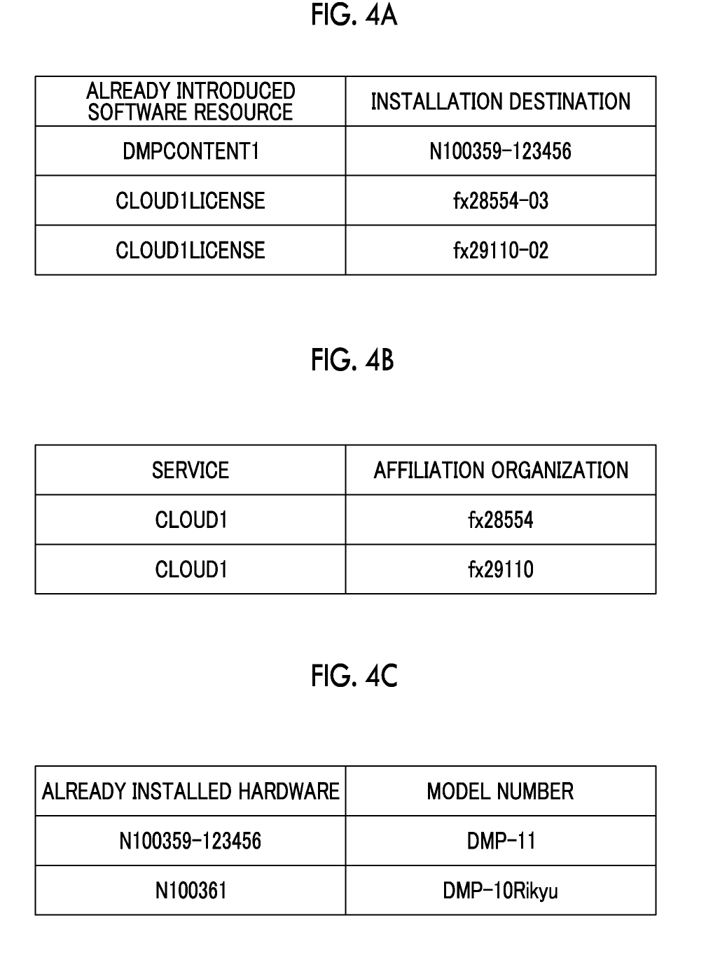

FIGS. 4A to 4C are diagrams showing an example of information held in the user environment information holding unit 10. FIG. 4A is a diagram showing software resource information, FIG. 4B is a diagram showing affiliation information, and FIG. 4C is a diagram showing hardware resource information. In the software resource information shown in FIG. 4A, the software resource which has already been introduced by the user are associated with the installation destinations thereof. In a case where the software resource is a software product, information indicating the hardware in which a software product is installed is recorded as the installation destination. On the other hand, in a case where the software resource is a service, information indicating the subject (license entity) who acquires the license as the installation destination is recorded. In the affiliation information shown in FIG. 4B, the service available to the user and the organization to which the user belongs are associated with each other. In the hardware resource information shown in FIG. 4C, hardware which has already been introduced (installed) and its model number are associated with each other.

In the software resource information, the installation destination of the software product is indicated by the identification information (hardware ID) of the hardware in which the software is installed. The license entity of the service is indicated by the identification information (user ID) of the user who uses the license. Referring to the software resource information in FIG. 4A, “DMPcontent1” of the software resource is installed in the hardware of the hardware ID “N100359-123456”. Here, the hardware may be the information apparatus 140. In addition, with respect to “cloud1license” which is the license to use the cloud service “cloud 1”, the user of the user ID “fx28554-03” and the user of the user ID “fx29110-02” are set as a license subjects. The user ID “fx28554-03” indicates the user specified by the identification number “03” belonging to the organization with the organization ID “fx28554”. Similarly, the user ID “fx29110-02” indicates the user specified by the identification number “02” belonging to the organization with the organization ID “fx29110”.

In the affiliation information, the organization to which the user belongs is indicated by organization identification information (organization ID). In the illustrated example, the service use authority is set for a tenant which is a unit of management in the user management server 120. Then, the user uses the service based on the use authority set for the tenant to which the user belongs. Referring to FIG. 4B, the user belonging to the organization with the organization ID “fx28554” and the user belonging to the organization with the organization ID “fx29110” can use “cloud 1” based on the use authority set in the tenant.

In the hardware resource information, the hardware is indicated by a hardware ID. Referring to FIG. 4C, the hardware model number with the hardware ID “N100359-123456” is “DMP-11”. The hardware model number with the hardware ID “N100361” is “DMP-10Rikyu”.

The software resource providing unit 20 is a processor that receives a request from a user and provides a software resource to the user. The software resource providing unit is an example of a software resource providing unit.

Software resources to be provided are software products or services which are products. Software resources are provided online. In a case of providing software resources, user authentication may be performed. User authentication may be performed by the providing server 110 or may be performed using an external authentication server (IdP: Identity Provider). As will be described in detail later, reception of a request from the user and provision of software resources are performed on an operation screen controlled by the operation screen controller 80.

The dependency information holding unit 30 is a holding unit that holds information on a dependency relationship between resources (software resources and hardware resources). Here, the dependency relationship means that the introduction state of a certain resource influences the introduction aspect of other resources. For example, only when a certain resource has already been introduced, in a case where another certain resource can be introduced, there is a dependency between these resources. When a certain resource has already been introduced, in a case where an introduction aspect of another certain resource is specified, there is a dependency between these resources. The aspect to be specified is, for example, the number of licenses that can be set, functions that can be used after introduction, and the like. In addition, there may be a negative dependency. For example, in a case where a certain resource has already been introduced and in a case where another certain resource cannot be introduced (both cannot be introduced into one user environment), there is a dependency relationship (exclusive dependency relationship) between these resources.

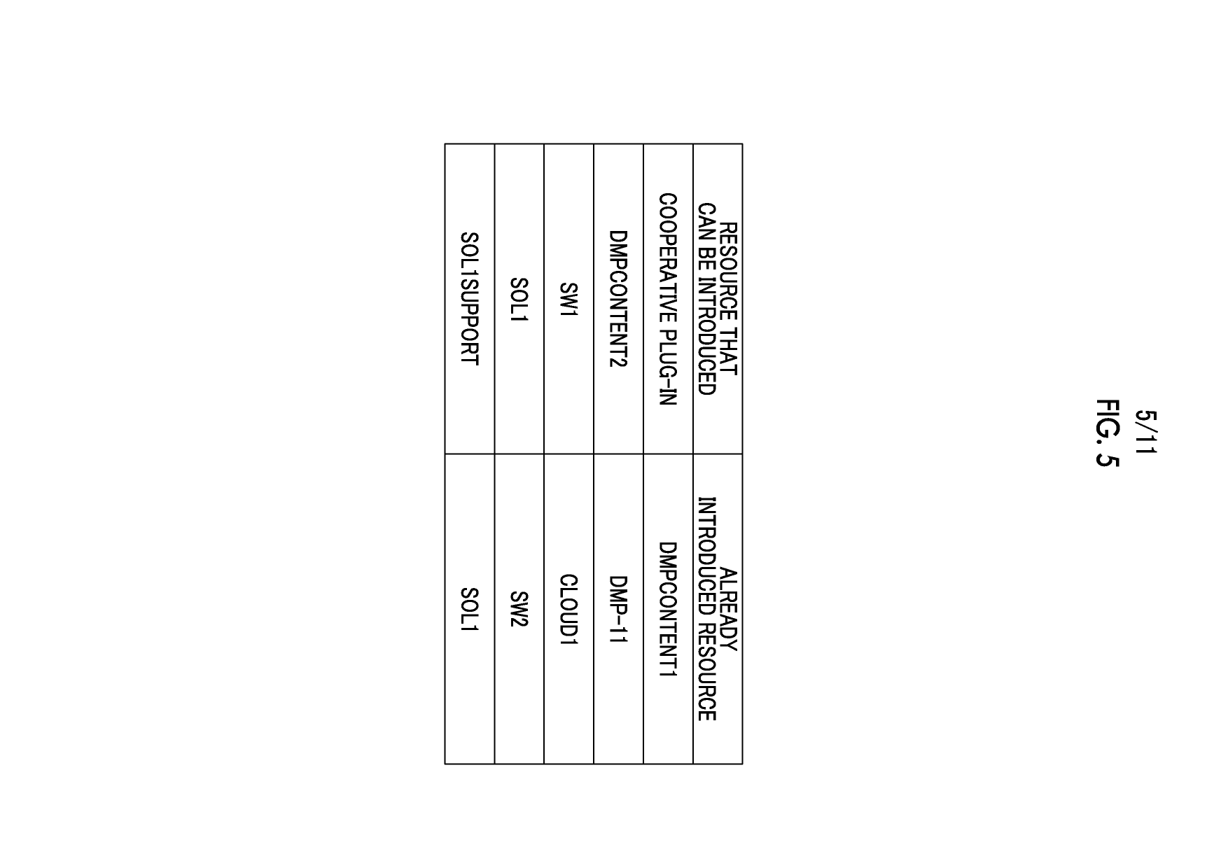

FIG. 5 is a diagram showing an example of information held in the dependency information holding unit 30. In the example shown in FIG. 5, one resource is associated with a resource that can be introduced in a case where the one resource has already been introduced. For example, in a case where “DMPcontent1” which is a software resource has already been introduced, “cooperative plug-in” can be further introduced to the hardware into which “DMPcontent1” is introduced. Further, in a case where hardware with a model number “DMP-11” has already been introduced, “DMPcontent2” can be introduced to the hardware. In addition, in a case where “cloud1” which is a service of a software resource has already been introduced, “SW1” of the software product can be installed in the hardware using the “cloud1”. In addition, in a case where software “SW2” has already been introduced, “SOL1” of the service can be introduced to the hardware in which the software “SW2” is installed. Further, in a case where “SOL1” has already been introduced, “SOL1support” can be introduced to the hardware using “SOL1”.

In FIG. 5, only dependency relationships as introduction permission conditions indicating resources that can be introduced in a case where one resource has already been introduced are described. On the other hand, as described above, it may be possible to include a dependency relationship as an introduction condition, specifying aspects which are available to introduce another one resource in a case where one resource has already been introduced, or a dependency relationship as an introduction refusal condition, indicating resources that cannot be introduced in a case where one resource has already been introduced.

The use environment specifying unit 40 is an example of a specifying unit that specifies an environment that can be constructed, including a software resource that the user wishes to newly introduce, based on the current user environment. In other words, the use environment specifying unit 40 specifies configurations of software resources that can be introduced, in consideration of dependency relationships among resources. The dependency relationship among resources considered includes the dependency relationship between the trial version software resource to be newly introduced and the software resources or hardware resources which have already been introduced into the current user environment, and the dependency relationship between the trial version software resources. The current user environment is obtained from the information held in the user environment information holding unit 10. The software resource that the user wishes to newly introduce is specified based on the request received by the software resource providing unit 20. The dependency relationship between resources is obtained from the information held in the dependency information holding unit 30. Here, the use environment specifying unit 40 excludes software resources determined not to be introduced based on the exclusive dependency relationship, among the software resources requested to the software resource providing unit 20 by the user, from the software resources that can be introduced. With respect to the software resource whose introduction aspect is specified based on the dependency relationship, an introduction aspect corresponding to the dependency relationship is set. For example, the number of licenses of newly introduced software resources is set according to the number of licenses set in the software resources which have already been introduced. Furthermore, instead of software resources determined to be impossible to introduce based on the dependency relationship, software resources having functions similar to those of the software resources and that can be introduced based on dependency relationships may be included in an environment that can be constructed.

The trial environment constructing unit 50 is a processor that constructs the environment specified by the use environment specifying unit 40 as the trial environment. Specifically, the trial environment constructing unit 50 prepares a trial version which is set depending on the dependency relationship between the software resource and hardware resource constituting the current user environment, with respect to the software resource, that can be introduced, specified by the use environment specifying unit 40 and introduces it into the user environment. In other words, the trial environment constructing unit 50 is an example of a trial environment providing unit. The trial environment constructing unit 50 installs the software product on the installation destination hardware (the client terminal 130 or the information apparatus 140), sets the authority (authority as a trial version) for using the service, and gives it to the user. Here, the authority for using the service is set based on the license (hereinafter, trial license) set in the trial software resource. The trial license is set separately from the license set in a case where the software resource is officially introduced. For this trial license, restrictions may be set different from licenses that are set at the time of official introduction regarding the service available period, the contents of available services, and the like. In the case where plural software products as trial version software resources are installed in the same hardware, they may be configured to be installed collectively by performing control and the like by the installer.

In accordance with the introduction of the trial version software resource, setting changes of the already introduced software resources and hardware resources constituting the existing user environment may be made to use the newly introduced trial version software resources. The setting changes of the already introduced resources are performed, for example, by transmitting an instruction to change the setting the resources to devices to which software resource which is a setting change target is introduced or devices which are hardware resources (hereinafter referred to as the setting change target device). The instruction to change the resource setting is generated by the trial environment constructing unit 50, for example. Therefore, the trial environment constructing unit 50 is an example of a setting change unit. By executing the received command, the setting change target apparatus changes the setting of each resource so that the trial version software resource can be used, according to the contents of the instruction.

The trial environment use information holding unit 60 is a holding unit that holds use information of software resources provided as a trial version in the trial environment constructed by the trial environment constructing unit 50. For example, the trial environment use information holding unit 60 extracts and holds the information on the use history of the trial version software resource from the use information of the software resource and the hardware resource stored in the user management server 120. The trial environment use information holding unit 60 is an example of a history information acquisition unit. The held information includes information on the installation destination of each trial version software resource and information on a job executed on each hardware constituting the trial environment. These pieces of information can be acquired from the user management server 120, for example. Further, it may be directly acquired from the client terminal 130 or the information apparatus 140 into which the trial version software resource is introduced.

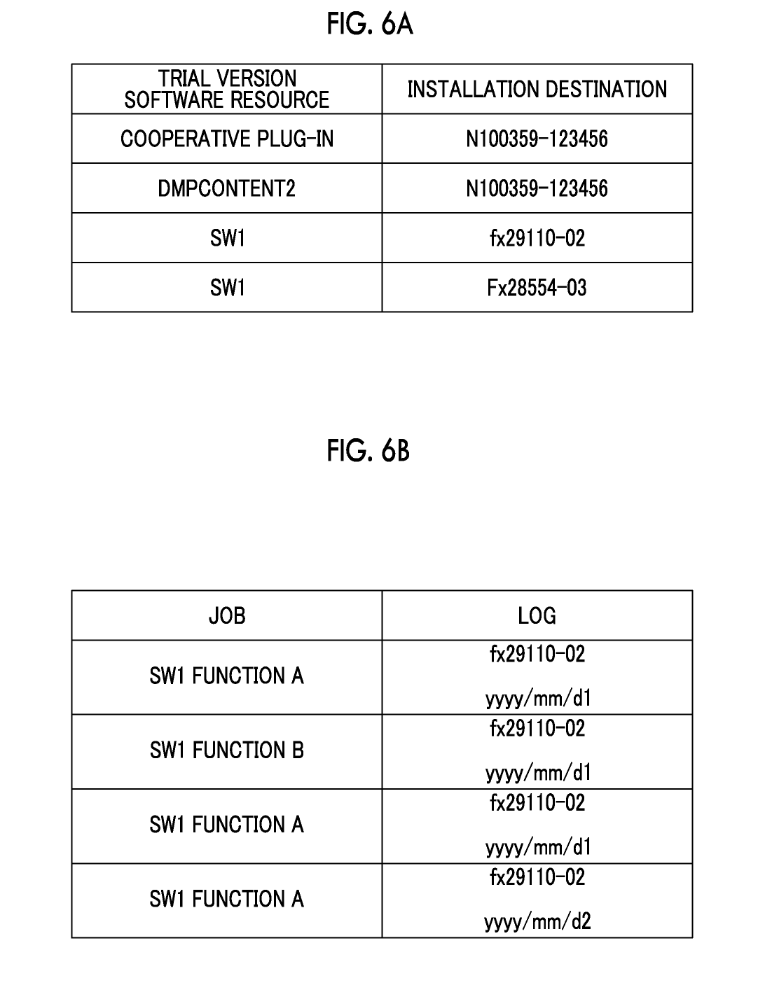

FIGS. 6A and 6B are diagrams showing an example of information held in the trial environment use information holding unit 60. FIG. 6A is a diagram showing installation destination information, and FIG. 6B is a diagram showing job execution information. In the installation destination information shown in FIG. 6A, trial version software resources are associated with their installation destinations. In a case where the trial version software resource is a software product, information indicating the hardware in which a software product is installed is recorded as the installation destination. On the other hand, in a case where the software resource is a service, information indicating the subject (license entity) who acquires the license as the installation destination is recorded. In the example shown in FIG. 6A, the trial version software resources “cooperative plug-in” and “DMPcontent2” are installed in the hardware with the hardware ID “N100359-123456”. “SW 1” of the software product is installed in the client terminal 130 of the user with the user ID “fx28554-03” and the client terminal 130 of the user with the user ID “fx29110-02”.

Here, referring to FIG. 5, “cooperative plug-in” can be introduced in a case where “DMPcontent1” has already been introduced. Referring to FIG. 4A, “DMPContent1” has already been introduced to the hardware of “N100359-123456”. Therefore, as shown in FIG. 6A, the “cooperative plug-in” can be introduced into the hardware of “N100359-123456”. Further, referring to FIG. 5, “DMPcontent2” can be introduced into hardware of model number “DMP-11”. Referring to FIG. 4C, the hardware model number of “N100359-123456” is “DMP-11”. Therefore, as shown in FIG. 6A, “DMPcontent2” can be introduced into the hardware of “N100359-123456”. Although not shown in FIG. 5, for example, a case is considered where there is a dependency relationship that “DMPcontent2” cannot be introduced into hardware into which “DMPcontent1” has already been introduced. In this case, as shown in FIG. 4A, since “DMPcontent1” has already been introduced into the hardware of “N100359-123456”, “DMPcontent2” cannot be introduced.

Further, referring to FIG. 5, the software “SW1” can be introduced in a case where the service “cloud1” has already been introduced. Referring to FIG. 4B, authority to use “cloud1” is set for the tenant corresponding to organization “fx28554” and organization “fx29110”. Referring to FIG. 4A, the user with the user ID “fx28554-03” and the user with the user ID “fx29110-02” each have “cloud1license”. Therefore, as shown in FIG. 6A, the software “SW1” can be installed in the client terminal 130 of the user with the user ID “fx28554-03” and the client terminal 130 of the user with the user ID “fx29110-02”.

In the job execution information shown in FIG. 6B, the job actually executed in the trial version software resource, the user ID of the user who executes the job, and the information (log) on the execution date of the job are associated with each other. In the example shown in FIG. 6B, the job by the function A of the software “SW1” is executed twice on the date “yyyy.mm.d1” and executed once on the date “yyyy.mm.d2”, in the client terminal 130 of the user with the user ID “fx29110-02”. Further, the job by the function B of the software “SW1” is executed once on the date “yyyy.mm.d1” in the client terminal 130 of the user with the user ID “fx29110-02”. That is, in the examples shown in FIGS. 6A and 6B, the software “SW1” is installed in the client terminal 130 of the user with the user ID “fx28554-03” and the client terminal 130 of the user with the user ID “fx29110-02” and use authority is authenticated (or authenticatable), but only the user with the user ID “fx29110-02” is executing the job using the software “SW 1”.

The recommended configuration specifying unit 70 is a specifying unit that specifies a recommended configuration depending on the use situation of the trial environment by the user in a case where the user intends to officially introduce the software resource provided as the trial version software resource. The recommended configuration is a candidate (provided candidate) of a combination of software resources recommended to be introduced (provided) in the user environment. That is, the recommended configuration specifying unit 70 is an example of a provision candidate specifying unit. The recommended configuration includes one or plural software resources. The use situation of the trial environment is specified based on the use information of the trial version software resource held in the trial environment use information holding unit 60. In addition to the types of software resources, the recommended configuration specifying unit 70 specifies the recommended number of licenses in a case where a license for using software resources is set. In addition, in a case where functions available for software resources can be restricted, functions of recommending or limiting introduction may be specified.

The recommended configuration specifying unit 70 may specify plural recommended configurations at different stages. For example, three stages of recommended configurations called a minimum configuration, a normal configuration, and a request configuration are specified. The minimum configuration is a minimum recommended configuration expected to be required by the user, based on the use situation of the trial environment by the user. That is, the minimum configuration is a candidate (first candidate) configured with trial version software resources which are actually used. Specifically, it is a configuration including only software resources and functions actually used by the user in the trial environment. In the example shown in FIGS. 6A and 6B, the software “SW1” is installed in both the client terminal 130 of the user with the user ID “fx28554-03” and the client terminal 130 of the user with the user ID “fx29110-02” (FIG. 6A), and the job of the software “SW1” is executed only in the client terminal 130 of the user with the user ID “fx29110-02” (FIG. 6B). Therefore, the minimum configuration is configured to introduce the software “SW1” with only the client terminal 130 of the user with the user ID “fx29110-02” as the installation destination. In the client terminal 130 of the user with the user ID “fx29110-02”, the job by the function A of the software “SW1” and the job by the function B are executed. Therefore, depending on the type of the software “SW1” and the dependency relationship between the functions, it may be configured to introduce the software “SW1” by restricting the functions other than the function A and the function B.

The normal configuration is a recommended configuration that is expected to be available to the user, based on the constructed trial environment. In other words, the normal configuration is a candidate (second candidate) configured with trial version software resources that are in a usable state for which use authority is authorized (activated). Specifically, regardless of whether it is actually used in the trial environment or not, it is a configuration that includes all the trial licenses for which the use authority is authenticated. In the example shown in FIGS. 6A and 6B, it is a configuration that the software “SW 1” is introduced, with both the client terminal 130 of the user with the user ID “fx28554-03” and the client terminal 130 of the user with the user ID “fx29110-02” as installation destinations.

The request configuration is a recommended configuration using the trial environment constructed based on the user's request as it is. That is, the normal configuration is a candidate (third candidate) configured with all trial version software resources constituting the trial environment. Therefore, the request configuration includes software or a service for a trial license for which the use authority is not authenticated and software or a service of which the use authority is authenticated but is not actually used, among trial version software resources included in the trial environment.

As a specific example, for a certain software resource, the trial environment is assumed to be constructed with the number of trial licenses as 10. It is assumed that the number of users who are in a usable state is 5 in a case of authenticating the use authority based on the trial license with respect to the trial version software resource. Further, it is assumed that the number of users who actually execute the job using the trial version software resource is 1. In this case, based on the use situation of the trial version software resource, the number of licenses set in a case where the software resource is officially introduced is 1 in the minimum configuration, 5 in the normal configuration, and 10 in the request configuration. In this manner, by referring to the authentication of the use authority and the execution of the job, which are actually performed based on the trial license, the number of licenses at the time of officially introducing the software resource can be set depending on the specific use situation of the user.

Further, the recommended configuration specifying unit 70 may not necessarily specify all of the minimum configuration, the normal configuration, and the request configuration as the recommended configuration. Further, configurations other than the above three types may be specified as recommended configurations. For example, in a case where the user introduces software resources through a tenant managed by the user management server 120, it is also possible to configure the recommended configuration with the number of licenses associated with the tenant and corresponding to the number of members of the organization to which the user belongs.

The operation screen controller 80 is screen control unit that generates and controls an operation screen for receiving an operation for utilizing software resources (including trial version software resources) in the trial environment. The operation screen is generated, for example, as a Web page. On the operation screen, operations on the functions of the software resource providing unit 20 and the trial environment constructing unit 50 are received. Specifically, a screen for receiving an operation to select a software resource to be introduced by presenting a software resource, a screen for receiving an operation to instruct constructing a trial environment using the selected software resource, a screen for receiving an operation to officially introduce a software resource after using the trial environment, or the like is generated according to the scene. Therefore, the operation screen controller 80 is an example of a presenting unit, an example of a selection receiving unit, an example of a provision instruction receiving unit, and is an example of an introduction instruction receiving unit.

The operation screen is generated, for example, in a case where the user belonging to a tenant opened in the user management server 120 logs in as a user to a tenant to which the user belongs, and is sent to the client terminal 130 of the user. The operation screen sent to each client terminal 130 is displayed by the display unit of the client terminal 130. Then, by operating the operation screen, the user instructs to select software resources to be newly introduced and construct a trial environment, and instructs to select and introduce a software resource to be officially introduced after trial use of the trial environment. In a case where the user performs an input operation or the like on the operation screen displayed on the display unit of the client terminal 130, the information of the operation contents is transmitted from the client terminal 130 to the providing server 110. In accordance with an instruction from the client terminal 130, the providing server 110 constructs a trial environment or provides software resources. In addition, the login is an operation for authenticating a user by using preset account information in order to use resources on the network 150 under the control of the user management server 120.

The transmission and reception controller 90 is a communication unit for communicating with the user management server 120, the client terminal 130, and the information apparatus 140. The transmission and reception controller 90 controls, for example, the network interface 206 shown in FIG. 3, and transmits and receives commands and data to and from the user management server 120, the client terminal 130, and the information apparatus 140 through the network 150.

Functional Configuration of User Management Server

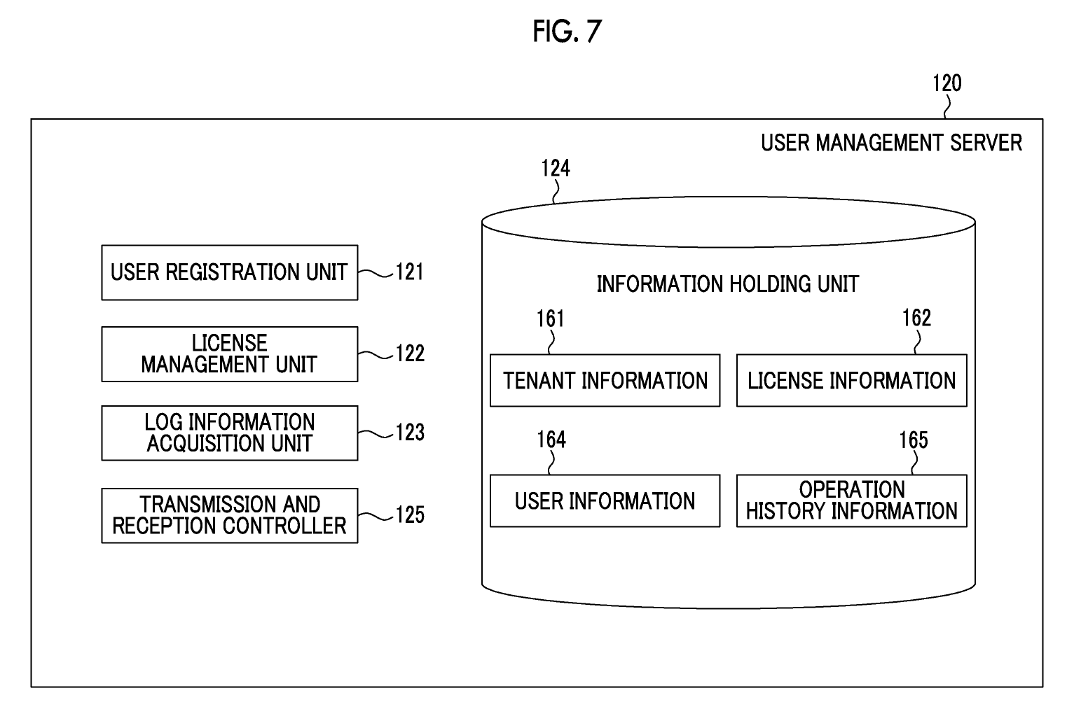

FIG. 7 is a diagram illustrating a functional configuration of the user management server 120. As shown in FIG. 7, the user management server 120 includes a user registration unit 121, a license management unit 122, a log information acquisition unit 123, an information holding unit 124, and a transmission and reception controller 125. Information such as users, tenants, and licenses are associated and stored in the information holding unit 124 in various ways. Details of each type of information will be described later. The functions of the user registration unit 121, the license management unit 122, and the transmission and reception controller 125 are realized, for example, by the CPU 201 executing a program in the computer 200 shown in FIG. 3. For example, the information holding unit 124 is realized by the main storage device 202 and the external storage device 203 in the computer 200 shown in FIG. 3.

The user registration unit 121 is a registration unit that registers a user managed by the user management server 120. The user is set and registered for each tenant, for example. For example, the user registration unit 121 may register the affiliation user on condition that the user is authenticated by an authentication server (not shown) connected to the network 150. As the authentication server, identity provider (IdP) may be used. IdP is a server that performs personal authentication of a user. The information on the registered user and the correspondence information between the tenant to which the user belongs and the user are stored in the information holding unit 124 as the user information 164.

The license management unit 122 is a management unit that manages licenses for using software resources. The license is individually set for each tenant, for example, and the license management unit 122 manages the set license for each tenant. The license information is stored in the information holding unit 124 as the license information 162. The license management unit 122 also manages the trial license set in the software resources in the trial environment.

The log information acquisition unit 123 is an information acquisition unit that acquires an execution log of a job using software resources and hardware resources by registered users who are management targets. The log information acquisition unit 123 acquires from the client terminal 130 or the information apparatus 140, an execution log obtained in accordance with the execution of the job. The obtained execution log is stored in the information holding unit 124 as the operation history information 165 in association with the user who instructs execution of the job. In order to associate the execution log with the user, it is premised that the user's personal authentication is performed. In the case of individual authentication in the information apparatus 140, for example, an employee ID card or the like by an IC card on which authentication information of the user is recorded is used. In a case where the user uses the information apparatus 140, authentication information of the IC card is read by the reading device provided in the information apparatus 140, and individual authentication is performed.

The information holding unit 124 is a storage unit that stores information on registered users who are management targets. The information holding unit 124 holds information on attributes of the user, information on tenants and organizations to which the user belongs, information on software resources and hardware resources available to the user, and the like. In the information holding unit 124, tenant information 161, license information 162, user information 164, and operation history information 165 of the information apparatus 140 are stored.

The tenant information 161 includes identification information of each tenant (tenant ID) set as a management unit, attribute information of each tenant (tenant attribute), and the like.

The license information 162 is generated in association with the tenant to which the license is set, and includes identification information of each license (license ID), attribute information of each license (license attribute), and the like. Incidentally, the license information includes similar information generated with regard to the trial license.

The user information 164 is generated in association with the tenant to which the user belongs, and includes identification information of each affiliation user (user ID), attribute information of each affiliation user (user attribute), and the like.

With respect to the operation (job) performed using the client terminal 130 or the information apparatus 140, the operation history information 165 includes information indicating the contents of the operation, the execution date and time of the operation, the user ID of the user who performs the operation, a tenant ID of a tenant to which the user belongs, a license ID of a license related to the information apparatus 140 set for a tenant specified by the tenant ID, and the like. In addition, the information held as the operation history information 165 includes history information on jobs performed using trial version software resources.

The transmission and reception controller 125 is a communication unit for communicating with the providing server 110, the client terminal 130, and the information apparatus 140. The transmission and reception controller 125 controls, for example, the network interface 206 shown in FIG. 3, and transmits and receives commands and data to and from the providing server 110, the client terminal 130, and the information apparatus 140 through the network 150.

Functional Configuration of Client Terminal

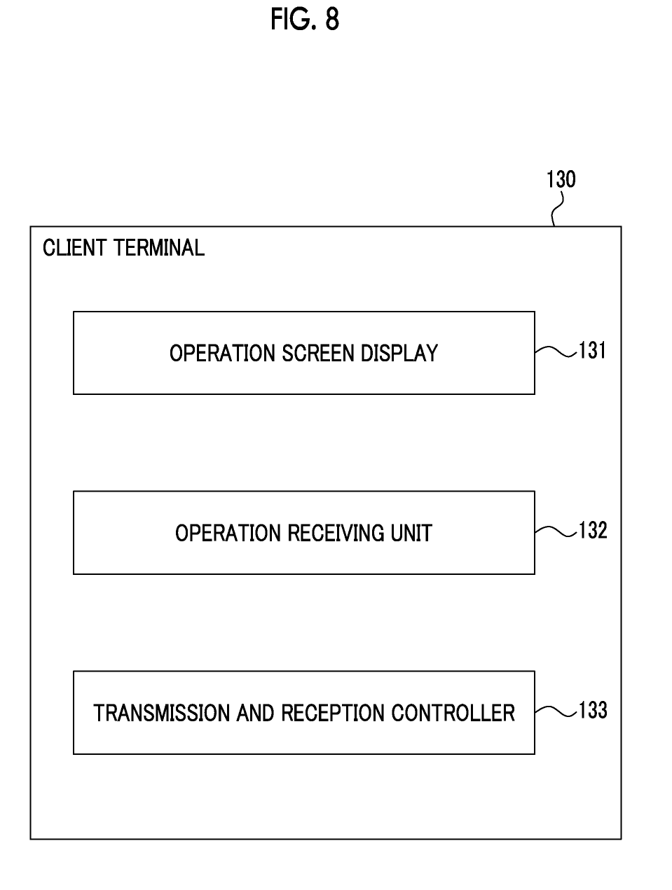

FIG. 8 is a diagram illustrating a functional configuration of the client terminal 130. As shown in FIG. 8, the client terminal 130 includes an operation screen display 131, an operation receiving unit 132, and a transmission and reception controller 133. The functions of the operation screen display 131, the operation receiving unit 132, and the transmission and reception controller 133 are realized, for example, by the CPU 201 executing a program in the computer 200 shown in FIG. 3.

The operation screen display 131 is a unit that displays an operation screen for using software resources and hardware resources. The operation screen display 131, for example, controls the display mechanism 204 shown in FIG. 3 to display the operation screen on the display device 210. Further, the operation receiving unit 132 is a unit that receives an operation executed on the operation screen as an operation for using a service, a software package, the function of the information apparatus 140, and the like. The operation receiving unit 132 receives, for example, an operation performed using the input device 205 shown in FIG. 3. As an example, in a case where the service, the software package, the functions of the information apparatus 140, or the like are provided using World Wide Web (WWW), the functions of the operation screen display 131 and the operation receiving unit 132 are realized by a Web browser.

The transmission and reception controller 133 is a communication unit for communicating with the providing server 110, the user management server 120, and the information apparatus 140. The transmission and reception controller 133 controls, for example, the network interface 206 shown in FIG. 3, and transmits and receives commands and data to and from the providing server 110, the user management server 120, and the information apparatus 140 through the network 150.

Example of Operation in Case of Constructing Trial Environment

In the present exemplary embodiment, in a case where the user intends to introduce a new software resource into his or her own user environment, the providing server 110 constructs a trial environment in which the trial version of software resources to be introduced into the current user environment is added, and provides it. The trial environment is constructed in consideration of the dependency relationship between software resources and hardware resources constituting the user environment and software resources to be introduced. Therefore, the user can try trial version software resources in the same environment as his or her own user environment constructed in a case of actually introducing new software.

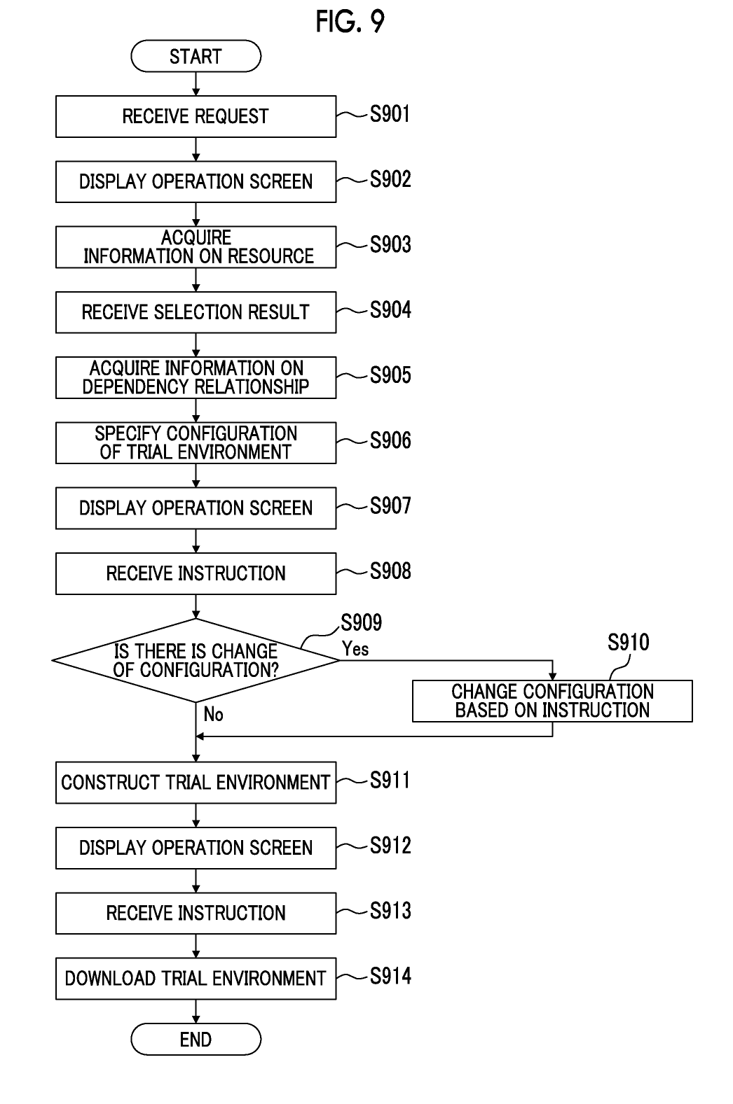

FIG. 9 is a flowchart showing operations of the providing server 110 in a case of constructing a trial environment. In a case of receiving a request for using the trial environment from the client terminal 130 (S901), the providing server 110 generates an operation screen for selecting a software resource to be introduced by the operation screen controller 80, and transmits the operation screen to the client terminal 130 to display it (S902). In addition, the providing server 110 acquires information on software resources and hardware resources constituting the current user environment from the user management server 120 (S903). In addition, with respect to the information on the software resources and the hardware resources constituting the user environment, information on the user environment of each client terminal 130 may be acquired in advance at predetermined timing (for example, periodically) from the user management server 120 and may be held in the user environment information holding unit 10. In addition, on the operation screen displayed on the client terminal 130 in S902, the software resource to be selected may be specified based on the dependency relationship between the software resources and the dependency relationship between the software resource and the hardware resource which have already been introduced in the user environment.

The user operates the operation screen displayed on the client terminal 130 to select a software resource desired to be introduced. The operation screen controller 80 of the providing server 110 receives the selection result made on the operation screen in the client terminal 130 (S904). In a case of receiving the selection result of the software resource by the user, the use environment specifying unit 40 of the providing server 110 reads the information on the dependency relationship between the selected software resource and each resource constituting the current user environment from the dependency information holding unit 30 (S905).

Next, the use environment specifying unit 40 specifies the configuration of the trial environment including the trial version of the software resource selected by the user, according to the dependency relationship between resources (S906). Then, the operation screen controller 80 presents the configuration specified by the use environment specifying unit 40, generates an operation screen for receiving the change of the configuration, and sends it to the client terminal 130 for display (S907). Here, the operation screen may be configured (for example, menu restriction, or the like) so that the configuration change can be performed only within a range without departing the dependency relationship of each resource.

The user operates the operation screen displayed on the client terminal 130, changes the configuration if necessary, and instructs construction of the trial environment. The operation screen controller 80 receives an instruction made on the operation screen in the client terminal 130 (S908). In a case where the instruction of the software resource by the user is received and there is an instruction to change the configuration, the use environment specifying unit 40 acquires the change instruction from the operation screen controller 80 and changes the configuration based on the instruction (S909, S910). Then, the trial environment constructing unit 50 of the providing server 110 constructs a trial environment based on the configuration specified by the use environment specifying unit 40 (S911). In a case where the trial environment constructing unit 50 constructs the trial environment, the operation screen controller 80 generates an operation screen for downloading the trial environment to the client terminal 130 and sends it to the client terminal 130 for display (S912).

The user operates the operation screen displayed on the client terminal 130 to instruct downloading of the trial environment. The operation screen controller 80 of the providing server 110 receives the instruction made on the operation screen in the client terminal 130 (S913). In a case where an instruction to download the trial environment by the user is received, the software resource providing unit 20 downloads the trial environment (S914). Here, among trial version software resources constituting the trial environment, software products are downloaded, and trial licenses for using services in the trial environment are given. In addition, among the software resources and hardware resources which have already been introduced, the setting change is made according to the dependency relationship, with respect to the resource having a dependency relationship with the trial version software resource. Thereafter, the user can test the trial environment in his or her client terminal 130 and the information apparatus 140 included in the trial environment.

Example of Operation in Case of Officially Introducing Software Resources

After trial use of the trial environment as described above, in a case where the user determines to officially introduce a new software resource, the providing server 110 provides the software resources in consideration of the use situation of the trial environment by the user. Trial use of the trial environment may be performed by setting a trial period, and it may be inquired from the providing server 110 whether or not to introduce the resource after the lapse of the period. Further, the trial of the trial environment may be continued until the client terminal 130 makes a request for official introduction. In the following, the operation will be described by taking the case where an inquiry is made from the providing server 110 after a predetermined trial period has elapsed.

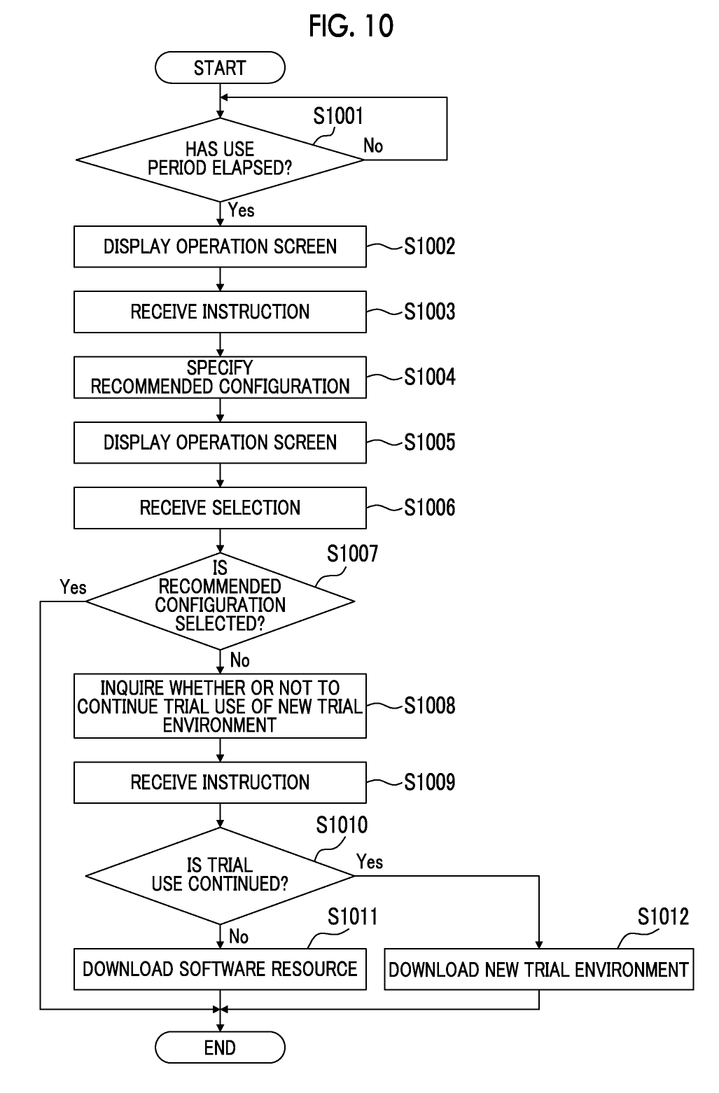

FIG. 10 is a flowchart showing operations of the providing server 110 in a case of officially introducing software resources. As a premise, the user management server 120 collects and accumulates use information of each resource in the trial environment. The use information accumulated in the user management server 120 is sent to the providing server 110 at a predetermined timing (for example, periodically, when the trial period elapses, or the like). The providing server 110 extracts the use information of the trial version software resource from the use information acquired from the user management server 120 and stores it in the trial environment use information holding unit 60. In the illustrated example, the use information is periodically acquired and stored in the trial environment use information holding unit 60.

In a case where the trial period has elapsed, the providing server 110 inquires whether or not to officially introduce the software resource, generates an operation screen for receiving the instruction, and transmits the operation screen to the client terminal 130 for display, by using the operation screen controller 80 (S1001, S1002).

The user operates the operation screen displayed on the client terminal 130 to instruct the official introduction of the software resource. The operation screen controller 80 receives an instruction made on the operation screen in the client terminal 130 (S1003). In a case where an instruction for official introduction by the user is received, the recommended configuration specifying unit 70 of the providing server 110 specifies the recommended configuration based on the use information of the trial version software resource held in the trial environment use information holding unit 60 (S1004). As an example, plural recommended configurations (for example, a minimum configuration, a normal configuration and a request configuration) of different stages are specified depending on the use situation of the trial version software resource. In a case where the recommended configuration is specified by the recommended configuration specifying unit 70, the operation screen controller 80 generates an operation screen for receiving the selection of the recommended configuration by the user and sends it to the client terminal 130 for display (S1005).

The user operates the operation screen displayed on the client terminal 130 to select the recommended configuration to be officially introduced. Here, the user may select as the installation environment, an environment other than the configuration presented as the recommended configuration. In this case, it may be possible to change the configuration (presence or absence and type of individual resources) and setting (number of licenses and additional functions) of the software resources based on one of the recommended configurations, or separately select a software resource to specify the introduction configuration. The operation screen controller 80 receives the selection made on the operation screen in the client terminal 130 (S1006). In a case where the selection by the user is received, the software resource providing unit 20 performs the following process.

In a case where the recommended configuration is selected (Yes in S1007), the software resource providing unit 20 downloads the software resource so as to construct the selected recommended environment (S1011). Here, among software resources that are officially introduced, software products are downloaded, and licenses for using services in the trial environment are given. In addition, among the software resources and hardware resources which have already been introduced, the setting change is made according to the dependency relationship, with respect to the resource having the dependency relationship with the officially introduced software resource. In addition, the trial version software resource may have been set as a trial version (function restriction or the like) of the software resource for official introduction. In this case, official introduction may be performed by canceling the setting as trial version from the trial version software resource constituting the trial environment which has already been introduced as user environment. As means for canceling the setting as the trial version, various existing methods such as a method of causing the user to input the release key or a method of simply canceling by the operation from the providing server 110 may be used. By the above, the software resources are officially introduced according to the selected recommended configuration. A user environment including the software resources provided as the recommended configuration is constructed.

In a case where an installation environment other than the recommended configuration is selected (No in S1007), the operation screen controller 80 generates an operation screen for inquiring whether or not to continue trial use of the selected installation environment as a new trial environment, and sends it to the client terminal 130 for display (S1008). The user operates the operation screen displayed on the client terminal 130 to instruct whether to continue the trial use of the trial environment or to officially introduce it into the selected installation environment. The operation screen controller 80 receives an instruction made on the operation screen in the client terminal 130 (S1009).

In a case where the trial use of the trial environment is not continued and the official introduction in the selected installation environment is instructed (No in S1010), the software resource providing unit 20 downloads the software resource so as to construct the selected installation environment (S1011). Thus, software resources constituting the selected installation environment are officially introduced, and a user environment including such software resources is constructed.

On the other hand, in a case where continuation of trial use of the trial environment is instructed (Yes in S1010), the use environment specifying unit 40 and the trial environment constructing unit 50 construct a trial environment corresponding to the selected installation environment, and the software resource providing unit 20 downloads the trial environment (S1012). Thus, the user can continue the trial use in a newly constructed trial environment.

Although the exemplary embodiment of the present invention has been described above, the technical scope of the present invention is not limited to the above exemplary embodiment. Various modifications and configuration alternatives without departing from the scope of the technical idea of the present invention are included in the present invention. For example, in the above exemplary embodiment, the providing server 110 that provides software resources and the user management server 120 that manages the user and authority to use resources by user are separated, but these functions may be realized by one server (site).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a specifying unit that specifies a software resource that can be provided to a user as a trial environment, based on information on a dependency relationship between resources including a software resource and a hardware resource and information on the software resource and the hardware resource in a use environment of the user; and
a presenting unit that presents the software resource specified by the specifying unit.

2. The information processing apparatus according to claim 1,
wherein the specifying unit specifies a combination of software resources that can be introduced together in one use environment as the software resource that can be provided as the trial environment, based on the dependency relationship.

3. The information processing apparatus according to claim 2,
wherein the specifying unit performs setting of the software resource in the specified combination of software resources, based on the dependency relationship.

4. The information processing apparatus according to claim 1, further comprising:
a provision instruction receiving unit that receives a provision instruction of the trial environment; and
a trial environment providing unit that provides software resources constituting the trial environment, based on an instruction received by the provision instruction receiving unit and the dependency relationship.

5. The information processing apparatus according to claim 4, further comprising:
a setting change unit that in a case where the trial environment providing unit provides the software resources, changes the setting of the software resource and the hardware resource in the use environment of the user, based on a dependency relationship between the provided software resource and the software resource and the hardware resource in the use environment of the user.

6. The information processing apparatus according to claim 1, further comprising:
a selection receiving unit that receives selection of a software resource to be introduced,
wherein the specifying unit specifies a software resource that can be provided as the trial environment, based on a dependency relationship between a software resource which is selected in a selection result received by the selection receiving unit and the software resource and the hardware resource in the use environment of the user.

7. The information processing apparatus according to claim 6,
wherein the specifying unit excludes a software resource that cannot be introduced together with the software resource and the hardware resource in the use environment of the user, among software resources selected by the user, from the software resources that can be provided as the trial environment, based on a dependency relationship between resources.

8. An information processing apparatus comprising:
a history information acquisition unit that acquires information on a use history of trial software resources provided as resources constituting a trial environment;
a provision candidate specifying unit that specifies candidates for software resources to be provided to a user, based on the information on a use history acquired by the history information acquisition unit, information on a dependency relationship between resources including software resources and hardware resources, and information on software resources and hardware resources in a use environment of the user; and
a presenting unit that presents the software resources specified by the provision candidate specifying unit.

9. The information processing apparatus according to claim 8,
wherein the provision candidate specifying unit specifies a plurality of candidates including at least any one of a first candidate configured with the trial software resources actually used, a second candidate configured with the trial software resources of which use authority is authenticated and which are in a usable state, or a third candidate configured with all the trial software resources constituting the trial environment, based on the information on a use history acquired by the history information acquisition unit, and
wherein the presenting unit presents the plurality of candidates specified by the provision candidate specifying unit.

10. The information processing apparatus according to claim 9, further comprising:
an introduction instruction receiving unit that receives an introduction instruction of software resources constituting one candidate selected from the plurality of candidates; and
a software resource providing unit that provides the software resources constituting the selected candidate according to the instruction received by the introduction instruction receiving unit.

11. An information processing apparatus comprising:
a specifying means for specifying a software resource that can be provided to a user as a trial environment, based on information on a dependency relationship between resources including a software resource and a hardware resource and information on the software resource and the hardware resource in a use environment of the user; and
a presenting means for presenting the software resource specified by the specifying means.
